(19) United States
(12) Patent Application Publication
(10) Pub. No.: US 2007/0091919 A1
(43) Pub. Date: Apr. 26, 2007

(54) Method and system of supporting enhanced television signaling

(76) Inventor: Francis R. Sandoval, Louisville, CO (US)

Correspondence Address: BROOKS KUSHMAN P.C., 1000 TOWN CENTER, TWENTY-SECOND FLOOR, SOUTHFIELD, MI, 48075, US

(21) Appl. No.: 11/257,098

(22) Filed: Oct. 24, 2005

(51) Int. Cl. H04J 3/16

(52) U.S. Cl. 370/466

(57) ABSTRACT

Method and system of supporting enhanced television (ETV) signaling. The method and system including combining multiple data types associated with ETV signaling in a common signal stream.

### BACKGROUND OF THE INVENTION

1. Field of the Invention

The present invention relates to methods and system of supporting enhanced television signaling.

2. Background Art

There have been various types of interactive applications designed by Network broadcasters, various application developers, and cable operators that are based on enhanced television (ETV) triggers embedded in the video stream. Many such applications are developed with the objective of generating additional revenue for the operator and/or the network or to enhance the television viewing experience of the subscriber. Providing such interactive enhancements entice the television viewer to watch more of the programming which promotes loyalty to the network and service provider.

The features and the objectives of these applications vary and hence the requirements for the technology to support these applications vary. The requirements for ETV triggers and supporting protocols can be classified into:
Accuracy of synchronization required with the video segment
Synchronization to the accuracy of a minute, second or millisecond.
Delivery of trigger data and application
Broadcast delivery vs. 2-way point-to-point delivery.
Broadcast through In-band MPEG private data sections, VBI data, or OOB.
Real-time vs. Non-real time communication between client and server.
   The following are some of the example applications that are based on triggers:
Interactive Advertising
Program synchronous applications
Interactive shows—Reality shows, series, and game shows
Game Quiz Trivia
News
Sports Event
Recorded Programming vs. Live Broadcast
Voting application e.g. CourtTV, Reality shows
Impulse upgrade promotions
E-commerce applications
Home Shopping
Music

The concept of ETV is not new and has been in industry for the last decade, however there has been little to no success in making an industry wide standard for implementing ETV that is widely used. The format developed by the Advanced Television Enhancement Forum (specifically ATVEF Transport A) was the closest that a specification came to becoming an industry standard and widely implemented on various platforms. Though it was implemented by a very few Internet television type receivers in the home, ATVEF was and probably is the most prevailing and popular ETV format ever used.

There are other industry standards bodies such as International Organization for Standardization (ISO), Society of Motion Picture and Television Engineers (SMPTE), and Advanced Television Systems Committee (ATSC) who have made efforts to define a format for inserting enhancements in a video stream. The ISO specifications for Digital Storage Media Control and Command (DSMCC) define a way of inserting events in the video stream that achieves better synchronization than most other techniques.

### SUMMARY OF THE INVENTION

One non-limiting aspect of the present invention relates to a transport stream for transporting signals associated with enhanced television (ETV), wherein the ETV requires the transport stream to include multiple data types, wherein at least a portion of the data types must relate to program association tables (PATs), program mapping tables (PMTs), video, audio, application information tables (AITs), application resources, media timelines, and stream events.

The transport stream may include a number of signaling streams for transporting signals associated with the data types with at least one of the signaling streams being an integrated signaling stream (ISS) having signals associated with a plurality of the data types.

The ISS may include at least one of the data types related to the AIT, media timeline, or stream events.

The signaling streams may be defined according to moving pictures expert group (MPEG) standards.

One non-limiting aspect of the present invention relates to a system for supporting enhance television (ETV). The system may include a number of ETV devices associated with supporting ETV, wherein at least a portion of the user devices are limited ETV devices having only 6 signaling streams filters. The system may further include a source configured generate a transport stream for transporting signals associated with the ETV to the user devices, wherein the transport stream includes a number of signaling streams having data types associated with program association tables (PATs), program mapping tables (PMTs), video, audio, application information tables (AITs), application resources, media timelines, and stream events.

Optionally, the source is configured to transport at least one of the signaling streams as an integrated signaling stream (ISS) having signals associated with a plurality of the data types so as to facilitate ETV with the user devices having only 6 signaling stream filters.

The ISS may include data types related to each of the AID, media timeline, and stream events. Optionally, at least a portion of the user devices are non-limited ETV devices having at least 8 signaling stream filters. The source may be configured to include at least 9 signaling streams within the transport such that at least one of the 9 signaling streams is associated with each of the PATs, PMTs, video, audio, AITs, application resources, media timelines, and stream events, and at least one of the 9 signaling streams is associated with the ISS so that non-limited devices filter the 8 signaling streams associated with the PATs, PMTs, video, audio, AITs, application resources, media timelines, and stream events, and the limited devices filter the 5 of the signaling streams associated with the PATs, PMTs, video, audio, application resources, and the ISS.

The source may be configured to receive 8 separate signaling streams and wherein each one of the signaling streams is associated with one of the PATs, PMTs, video, audio, AITs, application resources, media timelines, and stream events, and wherein the source is configured to convert the 8 signaling streams to the transport having the 6 signaling streams.

One non-limiting aspect of the present invention relates to a method of supporting enhance television (ETV) of the type wherein an ETV transport stream requires multiple signal streams for transporting signals associated with a number of data types used to support the ETV. The method may include combining multiple data types into one stream to provide an integrated signaling stream (ISS) having signals associated with the multiple data types such that the ETV is supported with a transport stream having the ISS as at least one of the signal streams.

The method may include determining the multiple data types combined into the ISS from the group comprising program association tables (PATs), program mapping tables (PMTs), video, audio, application information tables (AITs), application resources, media timelines, and stream events.

The method may include wirelessly transmitting the transport stream, transmitting the ETV signaling stream over a cable television network, packetizing the ETV signaling stream for transportation over a packet-switching network, such as according to Internet Protocol (IP), and/or combining only three data types into the ISS.

The above features and advantages, along with other features and advantages of the present invention, are readily apparent from the following detailed description of the invention when taken in connection with the accompanying drawings.

### BRIEF DESCRIPTION OF THE DRAWINGS

The present invention is pointed out with particularity in the appended claims. However, other features of the present invention will become more apparent and the present invention will be best understood by referring to the following detailed description in conjunction with the accompany drawings in which:

FIG. 1 illustrates a system for transporting enhance television (ETV) signals in accordance with one non-limiting aspect of the present invention;

FIG. 2 illustrates an ETV transport stream that may be used to support ETV in accordance with one non-limiting aspect of the present invention; and

FIG. 3 illustrates another ETV transport stream that may be used to support ETV in accordance with one non-limiting aspect of the present invention.

### DETAILED DESCRIPTION OF THE PREFERRED EMBODIMENT(S)

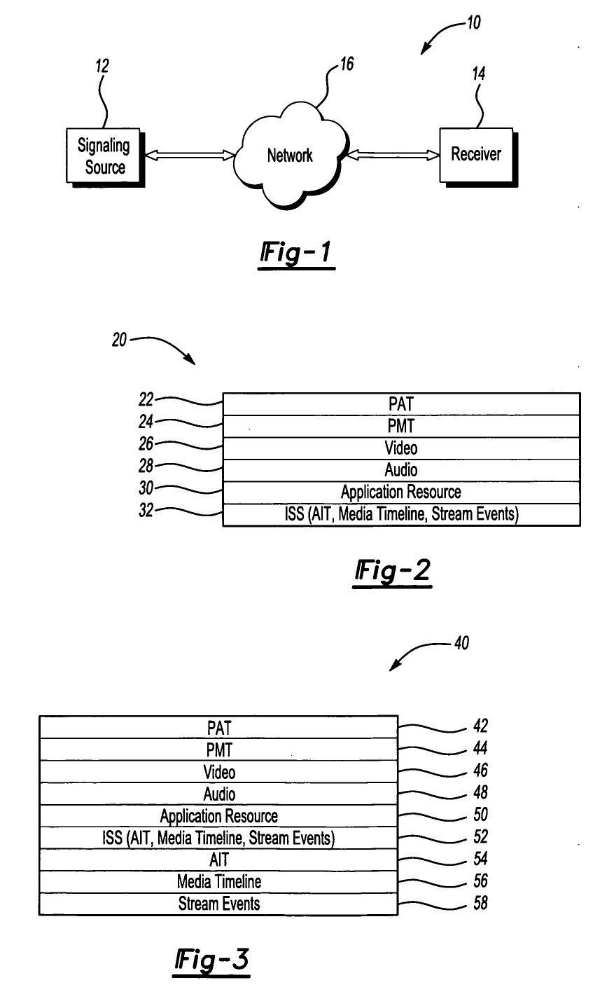

FIG. 1 illustrates a system 10 for transporting enhance television (ETV) signals in accordance with one non-limiting aspect of the present invention. The system 10 generally includes a signal source 12 for communicating signals associated with ETV to a receiver 14. The signals may be communicated over a network or other communication medium 16. The signals may be carried in a transport stream or other signal stream sufficient for supporting ETV.

The system 10 may be used in an number of environments to support ETV applications. For example, the network 16 may be associated with a cable network wherein a portion of the ETV signals may be carried over cable lines or other wireline/wireless features. Optionally, the network 16 may be associated with a satellite or other wireless network such that a portion of the ETV signals may be communicated wirelessly.

The ETV signals may be communicated according to any number of signaling strategies, standards, and protocols, including Advanced Television Enhancement Forum (ATVEF), Organization for Standardization (ISO), Society of Motion Picture and Television Engineers (SMPTE), Advanced Television Systems Committee (ATSC), Digital Storage Media Control and Command (DSMCC), Internet Protocol (IP), Hyper Text Transfer Protocol (HTTP), Dynamic Host Configuration Protocol (DHCP), Syslog, Simple Network Management Protocol (SNMP), Trivial File Transfer Protocol (TFTP), Data Over Cable Service Interface Specification (DOCSIS), Domain Name Server (DNS) applications, DOCSIS Settop Gateway (DSG), out-of-band (OOB) messaging, and others.

The ETV signals may be used to support any number of applications and features, including linear and non-linear television programming (cable, satellite, broadcast, etc.), Video on Demand (VOD), interactive television (iTV), interactive gaming, pay-per-view (PPV), interactive advertising, program synchronous applications, interactive shows (reality shows, series, game shows, etc.), game quiz trivia; news, sports event, recorded programming, voting applications (CourtTV, reality shows), impulse upgrade promotions, e-commerce applications, home shopping, music, and the like.

The receiver 14 may include any numbers of features and capabilities to support ETV and the applications associated therewith. The receiver 14 may be interfacing type device to interface a user with the ETV, such a settop box (STB) and television where the STB manipulates signals received from the signaling source for display and interaction with the user through the television. The STB may include an number of features and applications to support interaction and activities supported by the ETV signaling.

The present invention fully contemplates the receiver 14 being any number of devices/applications, having any number of capabilities, and is not intended to be limited to a STB and television combination. For example, the receiver 14 may comprise any suitable configured device or application, which may be a standalone or integrated feature, such as computer, media terminal adapter (MTA), personal digital assistant (PDA), outlet terminal adapter (ODA), mobile computing device, mobile/cellular phone, or any number of other devices having capabilities sufficient for interacting and communicating with the signaling source through one-way or two-way communications.

FIG. 2 illustrates an ETV transport stream 20 that may be used to support ETV in accordance with one non-limiting aspect of the present invention. The transport stream 20 may be outputted from the signaling source or other entity associated with the system. The receiver 14 may receive the transport stream 20 and perform any number of operations as function of signals carried therein in order to support ETV. The transport stream 20, for exemplary purposes, is described with respect to signaling streams commonly associated with the MPEG standard. This exemplary description is not intended to unduly limit the scope and contemplation of the present invention. Rather, the present invention contemplates the use of any transport stream having sufficient properties for supporting ETV.

The transport stream 20 may include a number of signaling streams 22-32. The signaling streams 22-32 may be used to package various signals within the transport stream 20. The signals may be associated with a number of data types commonly used in supporting ETV and/or the applications associated therewith. For example, the data types included within the signaling streams 22-32 may be associated with program association tables (PATs), program mapping tables (PMTs), video, audio, application information tables (AITs), application resources, media timelines, and stream events.

The PAT generally relates to information used as signaling stream identifiers, commonly referred to as packet identifiers (PIDs), included within the PMT. The PAT is signaled on a fixed logical place within the ETV transport stream. The PAT indicates the logical placement of the PMT, which lists all of the subcomponents of the ETV stream, by their PID, or packet identifier. The audio and video data types provide the audio and video portions of a television broadcast, movie on demand, or other similar multimedia broadcast.

The application resource data types are the components, resources, and other data needed by the receiver to support ETV applications and options. The AIT data types include information associated with facilitating acquiring and downloading ETV applications, including all application components, resources, and other data. The media timeline includes information associated with base, start, and end times for the audio and video. Media timeline messages provide the means by which a receiver may maintain a timeline relative to the media presentation. This timeline provides the reference point for applications to synchronize actions to the audio/visual presentation. The stream events includes information to instruct applications to perform actions relative to the audio/visual presentation, in terms of the media timeline.

Multiple data types may be combined or otherwise incorporated into a single signaling stream to form an integrated signaling stream (ISS). The ISS is shown to include the AIT, media timeline, and stream events data types, however, any one or more of the other data types may be included and/or used as substitutes. The ISS allows these eight commonly used data types to be transported in a transport stream having only six signaling streams.

One advantage of using a transport stream 20 having six signal streams 22-32 is that it allows limited capacity receivers to support ETV. Limited capacity receivers may be characterized as those having only six signaling stream filters, commonly referred to a PID filters. A PID filter may be needed for each signaling stream 22-32 such that a corresponding PID filter may be required for each stream 22-. If the transport stream includes eight signaling streams (one for each data type), then the receiver may need eight PID filters in order to access all the information carried in the transport stream that is needed to support ETV. Limited capacity receivers are unable to filter eight signaling streams, and therefore, would be unable to properly support ETV if more than six signaling streams are required. The present invention solves this problem by combining a plurality of the data types into a common signaling stream (ISS).

The formation of the ISS and the definitions, instructions, and other features attendant with supporting the operation thereof, as required by the present invention, may be selected and configured according to any number of protocols and standards associated with transporting the signals. For exemplary purposes, the foregoing example is made with respect to the signaling being associated with MPEG standards and definitions. These MPEG standards and definitions may be adjusted and re-defined to support the ISS and the interaction of the other signaling streams therewith, depending on the data types included therein.

FIG. 3 illustrates another ETV transport stream 40 that may be used to support ETV in accordance with one non-limiting aspect of the present invention. This ETV transport stream may include an number of signaling streams 42-58 signaling streams for each of the data types included within the ISS such that the transport stream 40 includes nine signaling streams 42-58, one for each data type and one for the ISS.

The transport stream 40 may be used with limited and non-limited capacity receivers to support ETV. As described above, the limited capacity receivers are those having a limited number of PID filters, i.e., some number less that the eight necessary for a typical ETV transport stream. The non-limited capacity receivers, however, include a sufficient number of PID filters to support the typical ETV transport stream, i.e., some number at least equal to or more than the eight necessary for a typical ETV transport stream.

In operation, the PMT specific the signaling streams 42-58 the PID filters to listen and look to for data, instructions, and other features. The PMT of this ETV signaling stream specifies these values in such a manner that the non-limited capacity receivers know to read each of the signaling streams but the ISS and so that the limited capacity receivers know to read each of the signaling streams but those having data types combined within the ISS.

As described above, any number of standards, protocols, and other definitional features may be used to define operations associated with the ISS. Hereinafter, one exemplary specification is provided for defining the transport stream to support ETV through the use of an ISS of the type described above. This example is provided for exemplary purposes and is not intended to limit the scope and contemplation of the present invention. The specification is described with respect to MPEG standards and protocols, but the present invention is not so limited.

2 References

2.1 Normative References

In order to claim compliance with this specification, it is necessary to conform to the following standards and other works (or portions thereof as indicated in this specification), in addition to the other requirements of this specification. Notwithstanding, intellectual property rights may be required to use or implement such normative references.
[IEC 13818-1] ISO/IEC 13818-1:2000, Information technology-Generic coding of moving pictures and associated audio information: Systems, 2000.
[IEC 13818-6] ISO/IEC 13818-6:1998(E), Information technology-Generic coding of moving pictures and associated audio information: Extensions for DSM-CC, 1998.
[OCAP1.0] OC-SP-OCAP1.0-I15-050415, OCAP 1.0 Profile, OpenCable Application Platform Specification, Apr. 15, 2005.
[MHP] ETSI TS 101 812 V1.3.1 (2003-06), DVB Multimedia Home Platform (MHP) 1.0.3.
[ETV-BIF] OC-SP-ETV-BIF1.0-I02-050727, OpenCable Enhanced Television (ETV) Binary Interchange Format 1.0, Jul. 27, 2005.
   2.2 Informative References
[HOST2.0] OC-SP-CCCP2.0-I02-050708, OpenCable Host 2.0 Core Functional Requirements, Jul. 8, 2005.
   2.3 Reference Acquisition
   CableLabs Specifications:
   Cable Television Laboratories, Inc., 858 Coal Creek Circle, Louisville, Colo. 80027; Phone 303-661-9100; Fax 303-661-9199; Internet: http://www.cablelabs.com
      ETSI Specifications:
   European Telecommunications Standards Institute, http://www.etsi.org
      ISO Specifications:
   International Organization for Standardization, http://www.iso.org
      3 Terms and Definitions

This specification uses the following terms:
Application Signal A broadcast message that provides information to a receiver necessary to acquire, launch, and terminate an ETV application.
Enhanced Television
(ETV) A general term that refers to interactive services and applications provided in conjunction with video programming.
Enhancement A software application that executes in conjunction with video programming.
Trigger A broadcast message that provides a synchronization mechanism to an enhancement. Triggers may be embedded in the associated video program, or delivered via another means such as OOB. Triggers may also be used for the delivery of unsolicited data to an enhancement.
User Agent An application running on a receiver that decodes and executes the enhancement.
   4 Abbreviations and Acronyms

This specification uses the following abbreviations:

AIT Application Information Table

DCII DigiCipher II

DTD Document Type Definition

DVR Digital Video Recorder

ETV Enhanced Television

EISS E TV Integrated Signaling Stream

IB In-band

NPT Normal Play Time

OOB Out-of-Band

PMT Program Map Table

PTS Presentation Time Stamp

VBI Vertical Blanking Interval

6 Enhanced Television Application Signaling

6.1 Introduction

This section defines the data formats and transmission mechanisms that enable receivers to discover, download, launch, and terminate ETV applications.

6.2 Content IDs

Many of the descriptors defined in this specification contain a field labeled content_id. Content_id is a unique identifier that ties together each of the descriptor elements related to a particular enhancement. This will allow, for example, an enhanced advertisement to interrupt an enhanced broadcast program by identifying all media timeline and trigger events by their content_id. Content_id needs only to be unique within a selected integrated signaling stream; it does not need to be unique across the entire transport stream or broadcast network.

6.3 Program Map Table Descriptors

The following PMT descriptors are defined by this specification:

ETV integrated signaling descriptor

ETV-BIF platform descriptor

6.3.1 ETV Integrated Signaling Descriptor

The etv_integrated_signaling_descriptor is defined for use in the elementary stream information loop of the PMT. This descriptor indicates that the associated elementary stream contains an ETV integrated signaling stream, as defined in Section 7 of this specification. Only one elementary stream signaled by the PMT SHALL contain an etv_integrated_signaling_descriptor. In the event that more than one PMT entry contains an etv_integrated_signaling_descriptor, the behavior of a baseline receiver is undefined. A PMT entry with an etv_integrated_signaling_descriptor MAY be associated with a stream_type of 0xC0 or 0x05.

The etv_integrated_signaling_descriptor is defined in Table 6-1.

TABLE 6-1
ETV Integrated Signaling Descriptor Syntax

| Syntax | Bits | Mnemonic |
|---|---|---|
| etv_integrated_signaling_descriptor( ) { | | |
| descriptor_tag, | 8 | uimsbf |
| descriptor_length, | 8 | uimsbf |
| for (i=0; i < n; i++) { | | |
| private_use | 8 | uimsbf |
| } | | |
| } | | |

| | |
|---|---|
| descriptor_tag | This 8-bit integer with value 0xA2 identifies this |
| | descriptor. |
| | Note: This value must be registered with DVB and is |
| | subject to change. |
| descriptor_length | This 8-bit integer indicates the number of bytes |
| | following the descriptor length field. |
| private_use | This field may be used to carry private data to a |
| | receiver or user agent which interprets this signaling |
| | stream. Its use is not defined by this specification. |

6.3.2 ETV-BIF Platform Descriptor

The etv_bif_platform_descriptor is defined for use in the elementary stream information loop of the PMT. This descriptor indicates to a receiver that the associated elementary stream carries ETV-BIF application resources. Furthermore, it identifies the initial page resource for the receiver to load when executing this application.

In the event that a particular initial page resource supports multiple hardware/software platforms (as identified by [ETV-BIF]) each of those platforms SHALL be listed in this descriptor. In the event that the application resources are spread across multiple elementary streams, the content_id field of the corresponding etv_bif_platform_descriptors SHALL be the same, allowing the user agent to use a common integrated signaling stream, while separating the application resources.

Resources that target baseline receivers SHALL be transmitted on a single elementary stream. Resources that target other receivers MAY be transmitted across multiple elementary streams. In this case, an etv_bif_platform_descriptor, which identifies the targeted platform, SHALL be included in the PMT entry that corresponds to each elementary stream carrying those resources. An elementary stream MAY contain multiple initial page resources, each of which targets a different collection of platforms. An elementary stream MAY also contain resources for multiple applications; (for example, one for the primary broadcast program and one for an enhanced advertisement). In each case, the PMT elementary stream information loop MAY contain multiple instances of an etv_bif_platform_descriptor.

The etv_bif_platform_descriptor is defined in Table 6-2.

TABLE 6-2
ETV-BIF Platform Descriptor Syntax

| Syntax | Bits | Mnemonic |
|---|---|---|
| etv_bif_platform_descriptor( ) { | | |
| descriptor_tag, | 8 | uimsbf |
| descriptor_length, | 8 | uimsbf |
| content_id, | 8 | uimsbf |
| initial_resource_locator_length | 8 | uimsbf |
| for (i=0; i < n; i++) { | | |
| initial_resource_locator | 8 | uimsbf |
| } | | |
| for (i=0; i < n; i++) { | | |
| etv_bif_platform_id( ) | | |
| } | | |
| } | | |

| | |
|---|---|
| descriptor_tag | This 8-bit integer with value 0xA1 |
| | identifies this descriptor. |
| | Note: This value must be registered |
| | with DVB and is subject to change. |
| descriptor_length | This 8-bit integer indicates the number |
| | of bytes following this field. |
| content_id | This 8-bit field uniquely identifies the |
| | enhancement which is being broadcast |
| | within this elementary stream. |
| initial_resource_locator_length | This 8-bit field indicated the length |
| | of the initial_resource_locator field |
| | which follows. |
| initial_resource_locator | This field identifies the locator for the |
| | initial page resource to be loaded |
| | by the receiver to execute the |
| | application identified by |
| | content_id. The format of this string is |
| | defined in [ETV-BIF]. |
| etv_bif_platform_id | This field contains an |
| | etv_bif_platform_id as defined in |
| | Table 6-3. If the associated elementary |
| | stream contains resources for more |
| | than one platform, this descriptor |
| | SHALL list all supported |
| | etv_bif_platform_ids. |

TABLE 6-3
ETV-BIF Platform ID Syntax

| Syntax | Bits | Mnemonic |
|---|---|---|
| etv_bif_platform_id( ) { | | |
| hw_manufacturer | 24 | uimsbf |
| hw_model | 16 | uimsbf |
| hw_version | 16 | uimsbf |
| sw_manufacturer | 24 | uimsbf |
| sw_model | 16 | uimsbf |
| sw_version | 16 | uimsbf |
| profile | 8 | uimsbf |

All fields in this table are defined in [ETV-BIF], section 9.5.

6.4 Application Signaling for Analog Services

Application Signaling for analog services is out-of-scope for this specification.

7 Enhanced Television Synchronization Signaling

Synchronization of an application to a video program requires the establishment of a reference media timeline. A media timeline allows a receiver to deliver stream events to an application at very specific points within the timeline.

OCAP devices are capable of using NPT descriptors and stream events embedded within a DSM-CC Object Carousel for this purpose as defined in sections 8.1 and 8.3 of DSM-CC [IEC 13818-6]. NPT descriptors establish the reference timeline. Stream events carry synchronous application data. Limited capability devices, however, are not capable of properly interpreting and processing the DSM-CC Object Carousel and the descriptors carried therein.

This section defines a set of descriptors which all devices are capable of receiving, designed for maintaining a media timeline and delivering synchronous data to an application.

Because of the limitations of the very low-end legacy receivers, there are requirements to combine the media timeline messages and stream events into a single, unified elementary stream. This unified stream SHALL also carry additional descriptors as identified in this section.

This unified stream SHALL be known as an ETV integrated signaling stream (EISS). It is possible that an operator MAY deliver an EISS as well as a DSM-CC object carousel with embedded NPT & stream event descriptors. In this case, the receiver MAY use the media timeline that is best suited for its capabilities.

7.1 EISS Table

The descriptors defined in this section are carried in an EISS Table. This table is contained in one or more MPEG-2 sections with syntax as specified in Table 7-1.

TABLE 7-1
EISS Section Syntax

| Syntax | Bits | Mnemonic |
|---|---|---|
| eiss_section ( ) { | | |
| table_id | 8 | uimsbf |
| section_syntax_indicator | 1 | bslbf |
| reserved | 3 | bslbf |
| section_length | 12 | uimsbf |
| filter_info | 16 | uimsbf |
| reserved | 8 | uimsbf |
| section_number | 8 | uimsbf |
| last_section_number | 8 | uimsbf |
| for (i=0; i < n; i++) { | | |
| eiss_descriptor ( ) | 8 | uimsbf |
| } | | |
| CRC_32 | 32 | rpchof |
| } | | |

| | |
|---|---|
| table_id | This 8-bit integer with value 0xE0 identifies |
| | this table. |
| | Note: This value must be registered with |
| | DVB and is subject to change. |
| section_syntax_indicator | The section_syntax_indicator is a 1-bit |
| | field that SHALL be set to 0. |
| reserved | This 3-bit field SHALL be set to 100. |
| section_length | This is a 12-bit field that specifies the |
| | number of bytes of the section starting |
| | immediately following the |
| | section_length field, and including |
| | the CRC_32 field (if present). The value |
| | in this field SHALL not exceed 1021. |
| filter_info | This 16-bit field is intended to |
| | accommodate hardware filtering of |
| | messages. This field SHALL convey the |
| | value 0xFBFA. |
| reserved | This 8-bit field SHALL be set to 0x00. |
| section_number | This 8-bit field gives the number of the |
| | section. The section_number of the first |
| | section in the sub_table SHALL be 0x00. |
| | The section_number SHALL be |
| | incremented by 1 with each additional |
| | section with the same table_id. |
| last_section_number | This 8-bit field specifies the number of the |
| | last section (that is, the section with the |
| | highest section_number) of the sub_table |
| | of which this section is part. |
| eiss_descriptor | Zero or more descriptors as specified in |
| CRC_32 | Section 7.2. This 32-bit field SHALL be |
| | set as defined in [IEC 13818-1]. |

7.2 EISS Descriptors

This section defines the following EISS descriptors:

ETV Application Information Descriptor

ETV Media Time Descriptor

ETV Stream Event Descriptor

7.2.1 ETV Application Information Descriptor

Because limited-capability devices cannot process normal AITs, the relevant fields from the AIT SHALL be embedded in the EISS as an application information descriptor, described in Table 7-2.

TABLE 7-2
ETV Application Information Descriptor Syntax

| Syntax | Bits | Mnemonic |
|---|---|---|
| etv_application_information_descriptor( ) } | | |
| descriptor_tag | 8 | uimsbf |
| descriptor_length | 8 | uimsbf |
| content_id | 8 | uimsbf |
| application_type | 16 | uimsbf |
| application_control_code | 8 | uimsbf |
| application_identifier( ) | 48 | bslbf |
| for (i=0; i < n; i++) { | | |
| private_data [ ] | 8 | uimsbf |
| } | | |
| } | | |

| | |
|---|---|
| descriptor_tag | This 8-bit integer with value 0xE0 identifies this |
| | descriptor. |
| | Note: This value must be registered with DVB and is |
| | subject to change. |
| descriptor_length | This 8-bit integer indicates the number of bytes |
| | following this field. |
| content_id | This 8-bit integer uniquely identifies the program |
| | being signaled, so that EISS descriptors for other |
| | nested events (such as advertisements) can be |
| | embedded in the same EISS. |
| application_type | This 16-bit integer identifies the type of application |
| | being signaled. DVB_MHP Section 10.4.6 Syntax of |
| | the AIT [MHP] includes Table 9, which defines the |
| | application_type field of the AIT. Table 7-3 |
| | extends the definition of the AIT Application Types as |
| | follows: |

TABLE 7-3
Application Types

| application_type | Description |
|---|---|
| 0x0008 | ETV-Binary Interchange Format (ETV-BIF) |
| | application |

Note: The application_type value must be registered with DVB and
is subject to change.

| | |
|---|---|
| application_control_code | This 8-bit integer controls the state of the |
| | application. The semantics of this field |
| | are application type-dependent. If the |
| | application_type field equals |
| | 0x0008 (ETV_BIF), this field is interpreted |
| | according to Table 7-4. |

TABLE 7-4
ETV-BIF Application Control Code Values

| Code | Identifier | Semantics |
|---|---|---|
| 0x00 | | reserved_for_future_use |
| 0x01 | AUTOSTART | The primary application resource is loaded |
| | | and the application is started, subject |
| | | to the usual restrictions, etc. |
| 0x02 | PRESENT | The primary application resource is loaded, |
| | | but is not started, pending the receipt |
| | | of another trigger, or Application |
| | | Information descriptor. |
| 0x03 | DESTROY | The application is signaled to quit by |
| | | generating a DESTROY event to the |
| | | application. |
| 0x04-0xff | | reserved_for_future_use |

| | |
|---|---|
| application_identifier | This 48-bit integer identifies the application |
| | according to DVB-MHP section 10.5 [MHP]. |
| private_data | This field is defined as private use is dependent |
| | upon the Application Type being signaled. If the |
| | Application Type is 0x0008 ([ETV-BIF]), this |
| | field SHALL be used to carry an |
| | application argument string as identified |
| | by [ETV-BIF] Section 9.6.9.7 |
| | Application Arguments. |

7.2.2 ETV Media Time Descriptor

ETV media time descriptors enable a receiver to maintain a program-specific timeline that can be referenced by a stream event for synchronization of an application to a broadcast program. This descriptor contains a value that allows the receiver to establish a unique time for each point within the program, even when that program is interrupted for advertisements or is joined in progress.

The ETV media time descriptor is defined in Table 7-5.

TABLE 7-5
ETV Media Time Descriptor Syntax

| Syntax | Bits | Mnemonic |
|---|---|---|
| etv_media_time_descriptor( ) } | | |
| descriptor_tag | 8 | uimsbf |
| descriptor_length | 8 | uimsbf |
| content_id | 8 | uimsbf |
| time_value | 32 | uimsbf |
| } | | |

| | |
|---|---|
| descriptor_tag | This 8-bit integer with value 0xE1 identifies this |
| | descriptor. |
| | Note: This value must be registered with DVB and is |
| | subject to change. |
| descriptor_length | This 8-bit integer indicates the number of bytes |
| | following the descriptor_length field. |
| content_id | This 8-bit integer uniquely identifies the program |
| | event to which the ETV media time descriptor |
| | belongs. |
| time_value | This field contains the time in milliseconds since the |
| | beginning of the current program. |

It is not necessary for a program to actually start at time 0, as long as the Stream Event descriptors tied to these time codes accommodate for the actual time values delivered in this stream.

7.2.3 ETV Stream Event Descriptor

ETV-BIF event descriptors carry application data to be delivered to an application synchronously with the broadcast event. The ETV-BIF event descriptor is defined in Table 7-6.

TABLE 7-6
ETV Stream Event Descriptor Syntax

| Syntax | Bits | Mnemonic |
|---|---|---|
| etv_bif_event_descriptor( ) } | | |
| descriptor_tag | 8 | uimsbf |
| descriptor_length | 8 | uimsbf |
| content_id | 8 | uimsbf |
| time_value | 32 | uimsbf |
| for (i=0, i < n; i++) { | | |
| payload_byte | 8 | uimsbf |
| } | | |
| } | | |

| | |
|---|---|
| descriptor_tag | This 8-bit integer with value 0xE2 identifies this |
| | descriptor. |
| | Note: This value must be registered with DVB and is |
| | subject to change. |
| descriptor_length | This 8-bit integer indicates the number of bytes |
| | following the descriptor_length field. |
| content_id | This 8-bit integer uniquely identifies the program |
| | event to which the ETV-BIF event belongs. |
| time_value | This field indicates the time at which the event |
| | SHOULD be delivered to the application on the |
| | receiver. There will be some inevitable delay based |
| | on the processing power of the receiver. If |
| | time_value is equal to 0, the event SHALL be |
| | delivered immediately. The format of this field is |
| | defined in Table 7-5. |
| payload_byte | This field contains application-dependent data. |

7.3 Synchronization in Analog Services

Synchronization and signaling for analog services is outside the scope of this document.

8 Carriage of ETV Application Resource Data

This section describes the carriage of ETV application resource data within an MPEG-2 Transport Stream. A common portable format must be established that may be interpreted by all receivers, and which can be generated by all authoring and packaging tools.

8.1 DSM-CC Data Carousel

If the Elementary Stream that carries ETV Resources is signaled with a stream_type of 0x0B (IEC 13818-6 Type B—DSM-CC Data Carousel [IEC 13818-6]), the application resource data is carried in a DSM-CC Data Carousel as defined in [IEC 13818-6]. No constraints are placed on the Data Carousel by this specification.

The contents of Sections 7 and 9 of [IEC 13818-6] are hereby incorporated into this specification; and, for the purposes of the OpenCable Contribution Agreement, SHALL be considered a “Contribution” to this specification, subject to the IPR terms and conditions (including each signatory's opportunity to provide notice) of the OpenCable Contribution Agreement.

8.2 Alternate Constrained Data Carousels

If the Elementary Stream that carries ETV Resources is signaled with a stream_type of 0xC0 (DCII Text Message), ETV Resources SHALL be encapsulated within a constrained data carousel as defined in Table 8-1. This constrained data carousel carries a DSM-CC_Section as defined in [IEC 13818-6]. The primary constraint imposed by this format is the limitation that each dc2_data_carousel_section is limited in size to less than 1 KB.

TABLE 8-1
DCII Data Carousel Message Syntax

| Syntax | Bits | Mnemonic |
|---|---|---|
| dc2_data_carousel_section( ) { | | |
| table_id | 8 | uimsbf |
| section_syntax_indicator | 1 | bslbf |
| reserved | 3 | bslbf |
| section_length | 12 | uimsbf |
| filter_info | 16 | uimsbf |
| reserved | 8 | bslbf |
| for (i=0; i < n; i++) { | | |
| dsmcc_section( ) | | |
| } | | |
| CRC32 | 32 | rpchof |
| } | | |

| | |
|---|---|
| table_id | This 8-bit integer with value 0xE3 or 0xE4 |
| | identifies this descriptor. |
| | Note: This value must be registered with |
| | DVB and is subject to change. |
| section_syntax_indicator | The section_syntax_indicator is a 1-bit |
| | field which SHALL be set to 0. |
| reserved | This 3-bit field is reserved by this |
| | specification and SHALL be set to ‘100’. |
| section_length | This 12-bit field specifies the number of |
| | bytes in the section starting immediately |
| | following the section_length |
| | field. The value in this field |
| | SHALL not exceed 1021, indicating that the |
| | encapsulated dsmcc_section SHALL have a |
| | maximum length of 1014 bytes. |
| filter_info | This 16-bit field is intended to |
| | accommodate hardware filtering of |
| | messages. If the enclosed dsmcc_section |
| | carries a DownloadInfoIndication (DII) |
| | message, this field will convey the value |
| | 0xFBFB. If the enclosed dsmcc_section |
| | carries a DownloadDataBlock message, this |
| | field conveys a copy of the moduleId field |
| | of the conveyed DSMCC |
| | DownloadDataBlock message. |
| | The set of values for the moduleId |
| | SHALL be limited to within the range |
| | 0x0001 and 0xFBEF. This enables a receiver |
| | to set hardware filters on all DSMCC DII |
| | control messages and specific download |
| | data modules in dsmcc_section sections. |
| reserved | This 8 bit field SHALL be set to 0x00. |
| dsmcc_section | This field carries a DSM-CC_Section as |
| | defined in [IEC 13818-6], table 9-2. When a |
| | DSM-CC section is encapsulated by a |
| | dc2_data_carousel_section the maximum |
| | length of that DSM-CC section is |
| | 1014 bytes. |
| CRC-32 | This field SHALL be set as defined |
| | in [IEC 13818-1], Annex B. |

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A transport stream for transporting signals associated with enhanced television (ETV), wherein the ETV requires the transport stream to include multiple data types, wherein at least a portion of the data types must relate to program association tables (PATs), program mapping tables (PMTs), video, audio, application information tables (AITs), application resources, media timelines, and stream events, the transport stream comprising:
a number of signaling streams for transporting signals associated with the data types; and
wherein at least one of the signaling streams is an integrated signaling stream (ISS) having signals associated with a plurality of the data types.

2. The transport stream of claim 1 wherein the ISS includes at least one of the data types related to the AIT, media timeline, or stream events.

3. The transport stream of claim 2 wherein the ISS includes data types related to each of the AIT, media timeline, and stream events.

4. The transport stream of claim 1 wherein the signaling streams are defined according to moving pictures expert group (MPEG) standards.

5. A system for supporting enhance television (ETV), the system comprising:
a number of ETV devices associated with supporting ETV, wherein at least a portion of the user devices are limited ETV devices having only 6 signaling streams filters;
a source configured generate a transport stream for transporting signals associated with the ETV to the user devices, wherein the transport stream includes a number of signaling streams having data types associated with program association tables (PATs), program mapping tables (PMTs), video, audio, application information tables (AITs), application resources, media timelines, and stream events;
wherein the source is configured to transport at least one of the signaling streams as an integrated signaling stream (ISS) having signals associated with a plurality of the data types so as to facilitate ETV with the user devices having only 6 signaling stream filters.

6. The system of claim 5 wherein the ISS includes at least one of the data types related to the AIT, media timeline, or stream events.

7. The transport stream of claim 5 wherein the ISS includes data types related to each of the AID, media timeline, and stream events.

8. The system of 7 wherein at least a portion of the user devices are non-limited ETV devices having at least 8 signaling stream filters, and wherein the source is configured to include at least 9 signaling streams within the transport, wherein at least one of the 9 signaling streams is associated with each of the PATs, PMTs, video, audio, AITs, application resources, media timelines, and stream events, and at least one of the 9 signaling streams is associated with the ISS such that non-limited devices filter the 8 signaling streams associated with the PATs, PMTs, video, audio, AITs, application resources, media timelines, and stream events, and the limited devices filter the 5 of the signaling streams associated with the PATs, PMTs, video, audio, application resources, and the ISS.

9. The system of claim 5 wherein the signaling streams are defined according to moving pictures expert group (MPEG) standards.

10. The system of claim 5 wherein the source is configured to receive 8 separate signaling streams and wherein each one of the signaling streams is associated with one of the PATs, PMTs, video, audio, AITs, application resources, media timelines, and stream events, and wherein the source is configured to convert the 8 signaling streams to the transport having the 6 signaling streams.

11. A method of supporting enhance television (ETV) of the type wherein an ETV transport stream requires multiple signal streams for transporting signals associated with a number of data types used to support the ETV, the method comprising:
combining multiple data types into one stream to provide an integrated signaling stream (ISS) having signals associated with the multiple data types such that the ETV is supported with a transport stream having the ISS as at least one of the signal streams.

12. The method of claim 11 further comprising determining the multiple data types combined into the ISS from the group comprising program association tables (PATs), program mapping tables (PMTs), video, audio, application information tables (AITs), application resources, media timelines, and stream events.

13. The method of claim 12 further comprising including only three of the data types from the group in the ISS such that at least six signal streams are included within the transport stream, one for the ISS and one for each of the data types not included within the ISS.

14. The method of 13 further comprising including three additional signal streams within the transport stream, one additional for each of the three data types included within the ISS, such that the transport stream includes nine signaling streams.

15. The method of claim 11 further comprising defining the transport stream according to moving pictures expert groups (MPEG) standards.

16. The method of claim 11 further comprising wirelessly transmitting the transport stream.

17. The method of claim 11 further comprising transmitting the ETV signaling stream over a cable television network.

18. The method of claim 11 further comprising packetizing the ETV signaling stream for transportation over a packet-switching network.

19. The method of claim 18 further comprising packetizing the ETV signaling stream according to Internet Protocol (IP).

20. The method of claim 11 further comprising combining only three data types into the ISS.
